(19) United States
(12) Patent Application Publication
(10) Pub. No.: US 2008/0144523 A1
(43) Pub. Date: Jun. 19, 2008

(54) Traffic Monitoring Apparatus, Entry Managing Apparatus, and Network System

(75) Inventors: Tetsuya Nishi, Kawasaki-shi (JP); Tomonori Gotoh, Kawasaki-shi (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/937,649

(22) Filed: Nov. 9, 2007

(30) Foreign Application Priority Data
Dec. 14, 2006 (JP) 2006-337072

(51) Int. Cl. G06F 11/30

(52) U.S. Cl. 370/253

(57) ABSTRACT

A plurality of traffic monitoring apparatuses and an entry managing apparatus common to the traffic monitoring apparatuses are provided in a network. In the traffic monitoring apparatus, a packet receiving unit extracts a source IP address, destination IP address, and a TTL count to be registered in an entry registering unit as an entry. A destination-address counting unit counts the number of entries having the same source IP address and the same TTL count. A TTL counting unit counts the number of entries having the same source IP address and the same destination IP address, and counts a largest TTL count. An entry reporting unit reports a TTL count or a largest TTL count to the entry managing apparatus. The entry managing apparatus identifies a traffic monitoring apparatus that has reported a TTL count having the largest value or a largest TTL count having the largest value, as an origin of an abnormality.

### CROSS-REFERENCE TO RELATED APPLICATIONS

This application is based upon and claims the benefit of priority from the prior Japanese Patent Application No. 2006-337072, filed on Dec. 14, 2006, the entire contents of which are incorporated herein by reference.

### BACKGROUND OF THE INVENTION

1. Field of the Invention

The present invention relates to a traffic monitoring apparatus, an entry managing apparatus, and a network system for detecting a failure in a network.

2. Description of the Related Art

In a communication network (internet protocol network) based on internet protocol (IP), abnormally heavy traffic caused by a network worm (hereinafter, “worm”) can interrupt a service. To avoid such a consequence, it is necessary to identify the closest terminal causing the failure such as a source of the worm quickly and accurately.

Therefore, conventionally, an IP address of the source of the worm is identified by capturing a packet passing a router, and by using the IP address to search a routing table, a route to the source is identified. Furthermore, for a packet transferred through a default route, a traceroute is issued to identify a route to the source.

A communication monitoring system that detects abnormalities in traffic from temporal changes in traffic volume is also conventionally known. This communication monitoring system has a traffic measuring unit, a statistic calculating unit, a feature-information retaining unit, a database unit, and an abnormality detecting unit. The traffic measuring unit measures the traffic of communication packets that pass through a network device in a predetermined measuring cycle. The statistic calculating unit performs statistical processing on one or more kinds of header information that is read from the communication packets. The feature-information retaining unit creates and retains feature information that has a plurality of feature items including a measurement result obtained by the traffic measuring unit and a calculation result obtained by the statistic calculating unit, for each measuring cycle. The database unit reads and stores, every time the feature-information retaining unit creates a new piece of the feature information, an old piece of the feature information from the feature-information retaining unit. The abnormality detecting unit detects an abnormality by reading, every time the feature-information retaining unit creates a new piece of the feature information, feature information that has one or more of the feature items determined to be consistent with that of the new piece of the feature information from the feature-information retaining unit, by statistically calculating a normal range for another feature item of the read feature information, and by comparing the other feature item and the normal range (for example, Japanese Patent Laid-Open Publication No. 2006-148686).

However, in the conventional method in which the routing table is referred, it takes time to identify a route to the source of the worm if there are a number of routers because each router must capture a packet to search the routing table. Moreover, even if a traceroute is issued, after the worm has already spread in a network or in the case where the IP address of the source of the worm is a false address, the source cannot be traced. Furthermore, with the communication monitoring system disclosed in Japanese Patent Laid-Open Publication No. 2006-148686, an abnormal state can be detected, however, the terminal causing the state or a route to the terminal cannot be identified.

### SUMMARY OF THE INVENTION

It is an object of the present invention to at least solve the problems in the conventional technologies.

A traffic monitoring apparatus according to one aspect of the present invention includes an extracting unit that extracts a source address, a destination address, and a time-to-live (TTL) count from a packet; an entry registering unit that registers the source address, the destination address, and the TTL count as an entry; a destination-address counting unit that counts number of entries having a same first combination and a different destination address, for each first combination, the first combination being a combination of a source address and a TTL count; and an entry reporting unit that reports, when the number of entries of the first combination exceeds a threshold, a source address and a TTL count of the first combination, the number of entries of which exceeds the threshold to a communication counterpart.

An entry managing apparatus according to another aspect of the present invention includes an entry collecting unit that collects entries each of which is formed with a combination of a source address and a TTL count by receiving the entries from a plurality of communication counterparts; and an entry comparing unit that compares TTL counts in the entries received from the communication counterparts for each source address, and that identifies a source that has sent an entry having a largest TTL count as an origin of an abnormality in a network.

A network system according to still another aspect of the present invention includes a plurality of traffic monitoring apparatuses that are provided in a network; and an entry managing apparatus that is common to the traffic monitoring apparatuses. Each of the traffic monitoring apparatus includes an extracting unit that extracts a source address, a destination address, and a TTL count; an entry registering unit that registers the source address, the destination address, and the TTL count as an entry; a destination-address counting unit that counts number of entries having a same first combination and a different destination address, for each first combination, the first combination being a combination of a source address and a TTL count; and an entry reporting unit that reports, when the number of entries of the first combination exceeds a threshold, a source address and a TTL count of the first combination, the number of entries of which exceeds the threshold to the entry managing apparatus. The entry managing apparatus includes an entry collecting unit that collects entries each of which is formed with a combination of a source address and a TTL count by receiving the entries from the traffic managing apparatuses; and an entry comparing unit that compares TTL counts in the entries received from the traffic monitoring apparatuses for each source address, and that identifies a traffic monitoring apparatus that has sent an entry having a largest TTL count as an origin of an abnormality in the network.

### BRIEF DESCRIPTION OF THE DRAWINGS

FIG. 1 is a schematic diagram of a network system according to an embodiment of the present invention;

FIG. 2 is a block diagram of a traffic monitoring apparatus and an entry managing apparatus according to the embodiment;

FIG. 3 is a schematic diagram showing a format of an IP packet;

FIG. 4 is a flowchart of a worm monitoring process performed by the traffic monitoring apparatus;

FIG. 5 is a flowchart of a worm-source identifying process performed by the entry managing apparatus;

FIG. 6 is a flowchart of an L3-loop monitoring process performed by the traffic monitoring apparatus;

FIG. 7 is a flowchart of an L3-loop-point identifying process performed by the entry managing apparatus;

FIG. 8 is a schematic diagram showing a worm-source identifying operation in a the network system;

FIG. 9 is a schematic diagram showing an L3-loop-point identifying operation in the network system; and

FIG. 10 is a schematic diagram showing the network system in another configuration.

### DETAILED DESCRIPTION OF THE PREFERRED EMBODIMENTS

Exemplary embodiments according to the present invention are explained in detail below with reference to the accompanying drawings.

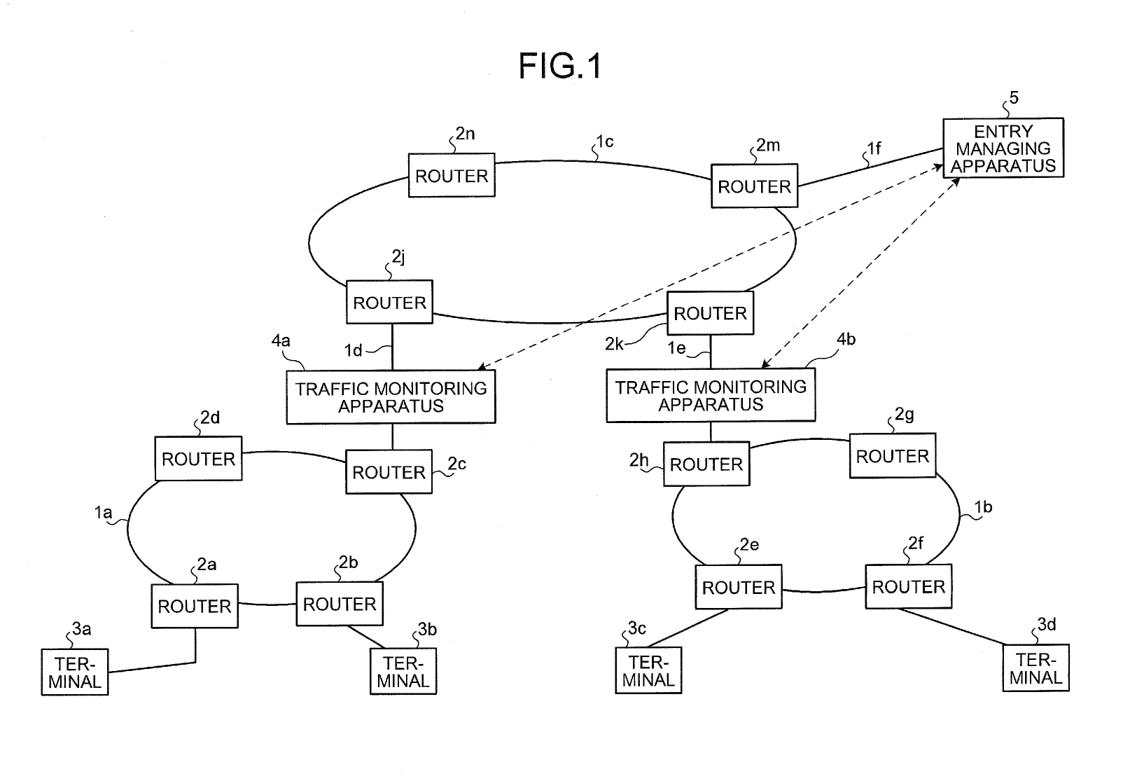

FIG. 1 is a schematic diagram of a network system according to an embodiment of the present invention. In FIG. 1, reference characters 1a, 1b, and 1c denote communication paths that form different networks, respectively. Reference characters 2a, 2b, 2c, and 2d, reference characters 2e, 2f, 2g, and 2h, and reference characters 2j, 2k, 2m, and 2n denote routers that are provided in the communication path 1a of a first network, the communication path 1b of a second network, and the communication path 1c of a third network, respectively. Reference characters 3a, 3b, 3c, and 3d denote terminals connected to the routers 2a, 2b, 2e, and 2f, respectively.

The router 2c in the first network and the router 2j in the third network are connected to each other through a communication path 1d. In the communication path 1d, a first traffic monitoring apparatus 4a that monitors packets passing through the communication path 1d is provided. Similarly, the router 2h in the second network and the router 2k in the third network are connected through a communication path 1e. Packets passing through the communication path 1e are monitored by a second traffic monitoring apparatus 4b.

An entry managing apparatus 5 is connected to the router 2m in the third network through a communication path 1f. The entry managing apparatus 5 identifies a point at which abnormal traffic has occurred, based on results of monitoring packets of the first and the second traffic monitoring apparatuses 4a and 4b.

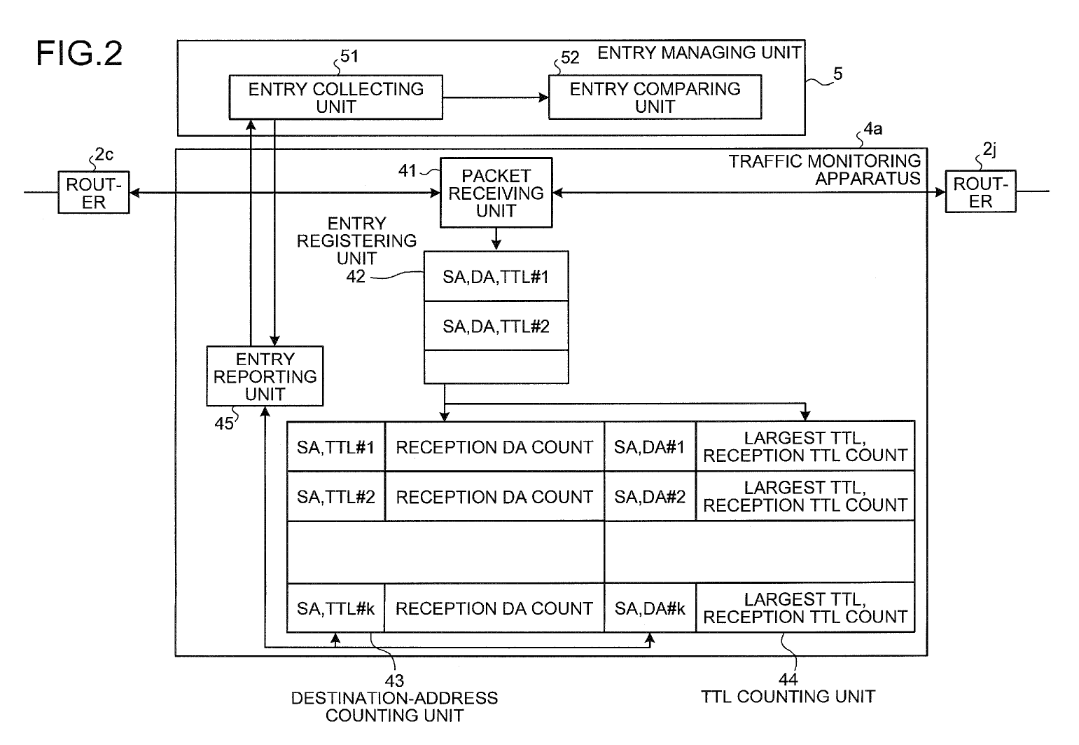

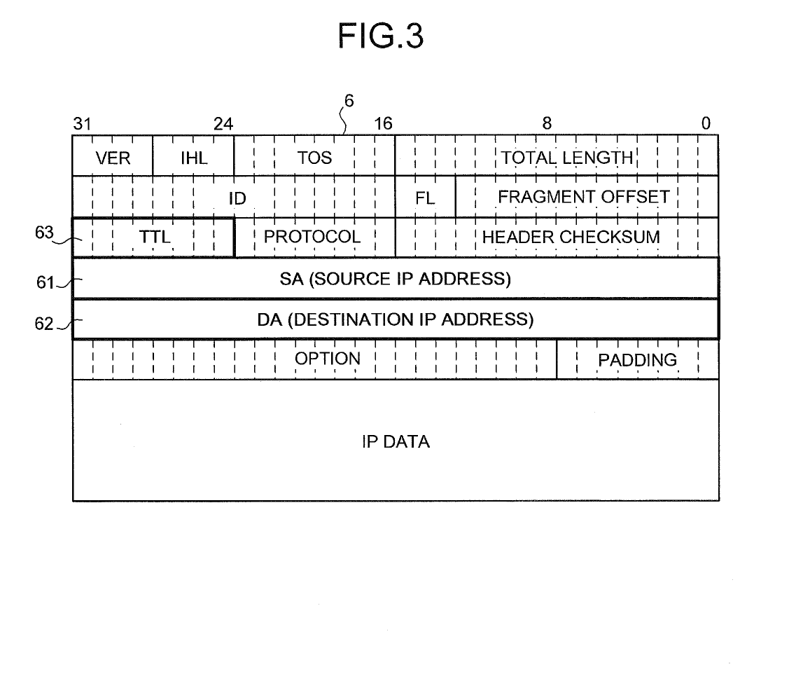

FIG. 2 is a block diagram of the traffic monitoring apparatus and the entry managing apparatus. The first traffic monitoring apparatus 4a and the second traffic monitoring apparatus 4b have the same configuration. Only the first traffic monitoring apparatus 4a (hereinafter, “traffic monitoring apparatus 4a”) is explained herein. FIG. 3 is a schematic diagram showing a format of an IP packet.

As shown in FIG. 2, the traffic monitoring apparatus 4a includes a packet receiving unit 41, an entry registering unit 42, a destination-address counting unit 43, a time-to-live (TTL) counting unit 44, and an entry reporting unit 45. The packet receiving unit 41 checks a header of an IP packet 6 (see FIG. 3) that is transferred from a router on one side to a router on another side, 2c to 2j, or 2j to 2c. The packet receiving unit 41 then extracts values stored in a source IP address portion 61, a destination IP address portion 62, and a TTL portion 63, and sends the values to the entry registering unit 42.

The entry registering unit 42 checks whether an entry having the same combination of source IP address, destination IP address, and TTL count as that sent from the packet receiving unit 41 has already been registered. If an entry having the same combination has not been registered, the entry registering unit 42 registers the combination as a new entry. On the other hand, if an entry having the same combination has been registered, the entry registering unit 42 increases the value in the destination-address counting unit 43 or the TTL counting unit 44.

The destination-address counting unit 43 has a counter to count, for each of the combinations, the number of entries having the same combination of source IP address and TTL count. The destination-address counting unit 43 increases the counter of an entry specified by the entry registering unit 42. When there is a combination of the source IP address and the TTL count whose counter value exceeds a threshold, the destination-address counting unit 43 notifies the entry reporting unit 45 of the source IP address and the TTL count of such combination.

The threshold of the counter is set in advance. Such configuration enables to grasp the TTL count of abnormal traffic, such as a packet being sent to various destination IP addresses.

The TTL counting unit 44 has a counter to count, for each of the combinations, the number of entries having the same combination of the source IP address and the destination IP address. Moreover, for each of the combinations of the source IP address and the destination IP address, the TTL counting unit 44 stores the largest TTL count among the TTL counts of all entries included in the respective combinations. When there is a combination of the source IP address and the destination IP address whose counter value exceeds a threshold, the TTL counting unit 44 notifies the entry reporting unit 45 of the source IP address and the largest TTL count of such combination.

The threshold of the counter of the TTL counting unit 44 is also set in advance. Such configuration enables to grasp the TTL count of abnormal traffic, such as a packet being sent many times with a different TTL count even though the combination of the source IP address and the destination IP address is the same.

The entry reporting unit 45 reports, to the entry managing apparatus 5, the source IP address and the TTL count that are reported by the destination-address counting unit 43. Furthermore, the entry reporting unit 45 reports, to the entry managing apparatus 5, the source IP address and the largest TTL count that are reported by the TTL counting unit 44. The entry reporting unit 45 can be configured to report, to the entry managing apparatus 5, every receipt of reporting from the destination-address counting unit 43 or the TTL counting unit 44. Alternatively, the entry reporting unit 45 can be configured to include a timer function and to report to the entry managing apparatus 5 regularly, for example, at the end of each monitoring cycle.

As shown in FIG. 2, the entry managing apparatus 5 includes an entry collecting unit 51 and an entry comparing unit 52. The entry collecting unit 51 collects source IP addresses and TTL counts of entries that are reported by the traffic monitoring apparatuses 4a and 4b. The entry collecting unit 51 can collect source IP addresses and TTL counts of the entry reporting unit 45 in each of the traffic monitoring apparatuses 4a and 4b regularly, for example, at the end of each monitoring cycle.

The entry comparing unit 52 compares TTL counts of a plurality of entries that are sent from the entry collecting unit 51, for each source IP address. The entry comparing unit 52 identifies a traffic monitoring apparatus that reports the largest TTL count as an origin of the abnormality.

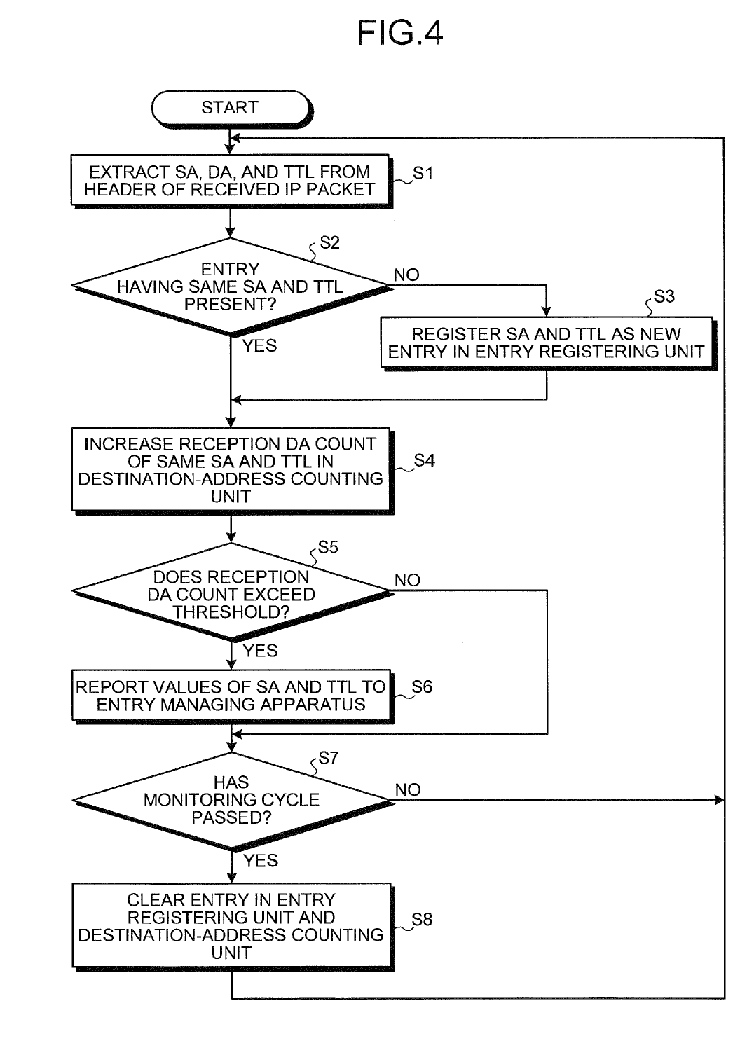

FIG. 4 is a flowchart of a worm monitoring process performed by the traffic monitoring apparatus. As shown in FIG. 4, when the worm monitoring process is started in the traffic monitoring apparatus 4a, an IP packet that passes between the routers 2c and 2j is first received, and a source IP address (SA), a destination IP address (DA), and a TTL count (TTL) are extracted from the header portion of the IP packet (step S1).

Subsequently, it is determined whether an entry having the same combination of source IP address and TTL count as that extracted is present in the entry registering unit 42 (step S2). When an entry having the same combination is not present (step S2: NO), the combination of the source IP address and the TTL count is registered as a new entry in the entry registering unit 42 (step S3), and then, the process proceeds to step S4.

On the other hand, when an entry having the same combination is present (step S2: YES), a reception DA count (counter value) of the entry having the same combination in the destination-address counting unit 43 is increased (step S4). When the process of step S4 is performed following the process of step S3, the reception DA count in the destination-address counting unit 43 of the entry that is newly registered in the entry registering unit 42 at step S3 is set to 1.

Subsequently, it is determined whether the reception DA count of the destination-address counting unit 43 exceeds a threshold (step S5). When the reception DA count exceeds the threshold (step S5: YES), the source IP address and the TTL count of the entry whose reception DA count exceeds the threshold are reported to the entry managing apparatus 5 (step S6). When the reception DA count does not exceed the threshold (step S5: NO), reporting to the entry managing apparatus 5 is not performed.

It is then determined whether a predetermined monitoring cycle has passed (step S7). When the predetermined monitoring cycle has passed (step S7: YES), the entry in the entry registering unit 42 and the counter value of the destination-address counting unit 43 are both initialized (step S8), and the process returns to step S1. When the predetermined monitoring cycle has not passed (step S7: NO), the entry in the entry registering unit 42 and the counter value of the destination-address counting unit 43 are not changed, and the process returns to step S1. Hereafter, the sequence of the worm monitoring process described above is repeated.

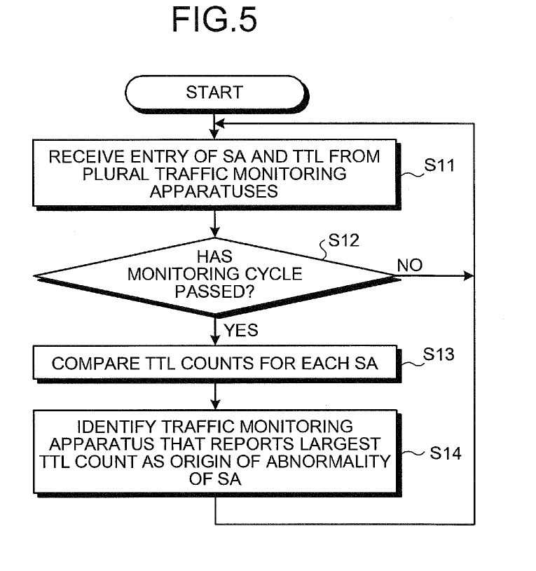

FIG. 5 is a flowchart of a worm-source identifying process performed by the entry managing apparatus. As shown in FIG. 5, when the worm-source identifying process is started in the entry managing apparatus 5, an entry including a source IP address and a TTL count is first received from the traffic monitoring apparatuses 4a and 4b (step S11). Subsequently, it is determined whether a predetermined monitoring cycle has passed (step S12). When the predetermined monitoring cycle has not passed (step S12: NO), the process returns to step S11.

When the predetermined monitoring cycle has passed (step S12: YES), TTL counts of entries are compared for each source IP address (step S13). The traffic monitoring apparatus that reports the largest TTL count is identified as the origin of the abnormality (step S14), and the process returns to step S11. Hereafter, the sequence in the worm-origin identifying process described above is repeated.

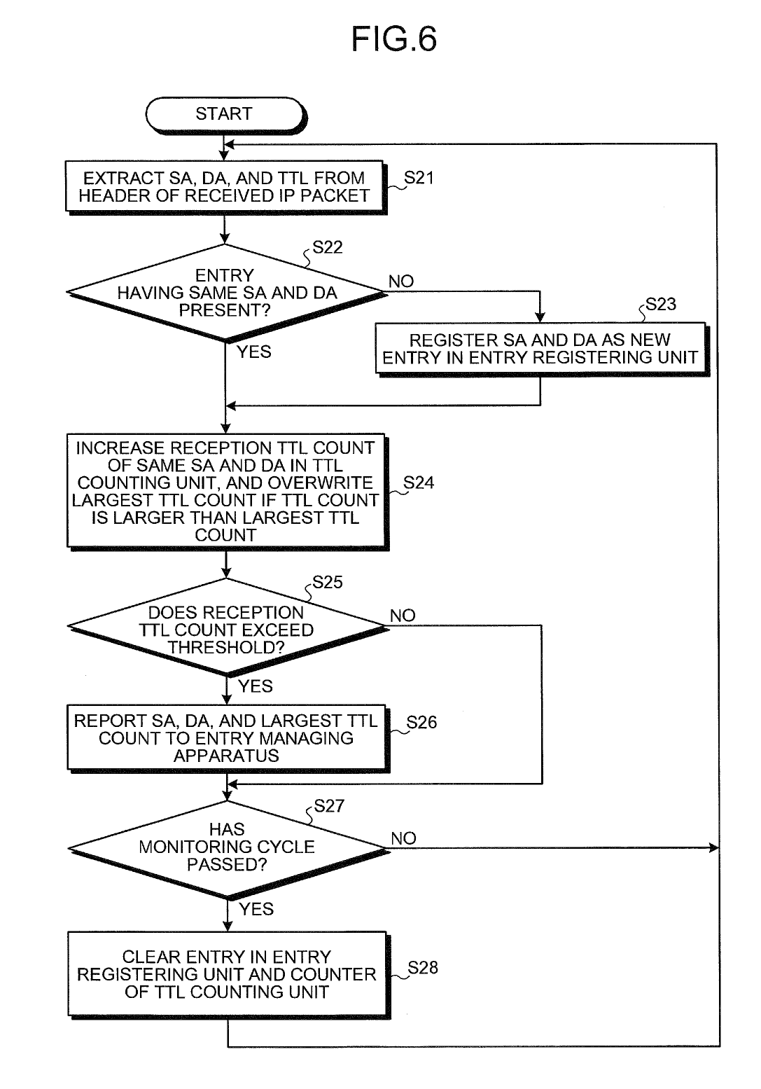

FIG. 6 is a flowchart of an L3-loop monitoring process performed by the traffic monitoring apparatus. As shown in FIG. 6, when the L3-loop monitoring process is started in the traffic monitoring apparatus 4a, an IP packet passing between the routers 2c and 2j is first received, and a source IP address, a destination IP address, and a TTL count are extracted from the header portion of the IP packet (step S21).

It is then determined whether an entry having the same combination of source IP address and destination IP address as that extracted is present in the entry registering unit 42 (step S22). When an entry having the same combination is not present (step S22: NO), the combination of the source IP address and the destination IP address is registered as a new entry in the entry registering unit 42 (step S23), and then, the process proceeds to step S24.

On the other hand, when an entry having the same combination is present (step S22: YES), a reception TTL count (counter value) of the entry having the same combination in the TTL counting unit 44 is increased. Furthermore, when the TTL count extracted at step S21 is larger than the largest TTL count of the entry having the same combination of source IP address and the destination IP address, the largest TTL count is overwritten with the extracted TTL count (step S24). Thus, the largest TTL count is updated.

When the process of step S24 is performed following the process of step S23, the reception TTL count in the TTL counting unit 44 of the entry that is newly registered in the entry registering unit 42 at step S23 is set to 1. Further, the TTL count extracted at step S21 is determined as the largest TTL count.

Subsequently, it is determined whether the reception TTL count of in the TTL counting unit 44 exceeds a threshold (step S25). When the reception TTL count exceeds the threshold (step S25: YES), the source IP address, the destination IP address, and the largest TTL count of the entry whose reception TTL count exceeds the threshold are reported to the entry managing apparatus 5 (step S26). When the reception TTL count does not exceed the threshold (step S25: NO), the reporting to the entry managing apparatus 5 is not performed.

It is then determined whether a predetermined monitoring cycle has passed (step S27). When the predetermined monitoring cycle has passed (step S27: YES), the entry in the entry registering unit 42 and the counter value of the TTL counting unit 44 are both initialized (step S28), and the process returns to step S21. When the predetermined monitoring cycle has not passed (step S27: NO), the entry in the entry registering unit 42 and the counter value of the TTL counting unit 44 are not changed, and the process returns to step S21. Hereafter, the sequence in the L3-loop monitoring process described above is repeated.

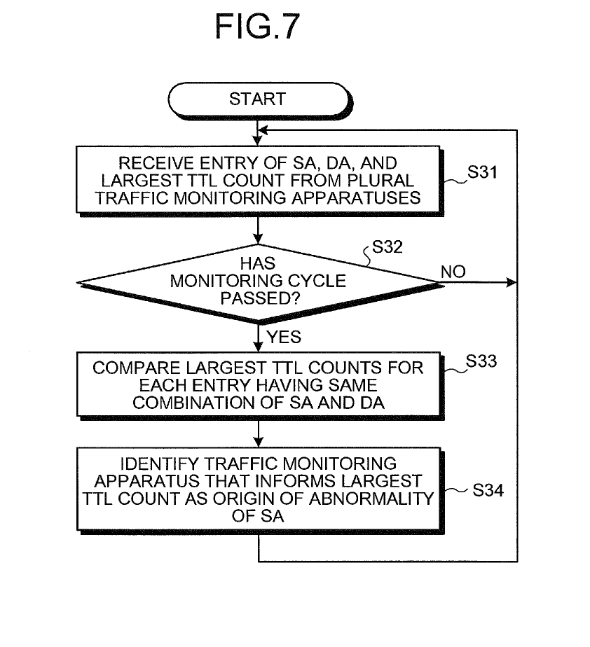

FIG. 7 is a flowchart of an L3-loop-point identifying process performed by the entry managing apparatus. As shown in FIG. 7, when the L3-loop-point identifying process is started in the entry managing apparatus 5, an entry including a source IP address, a destination IP address, and a largest TTL count is first received from the traffic monitoring apparatuses 4a and 4b (step S31). Subsequently, it is determined whether a predetermined monitoring cycle has passed (step S32). When the predetermined monitoring cycle has not passed (step S32: NO), the process returns to step S31.

When the predetermined monitoring cycle has passed (step S32: YES), the largest TTL count for each entry having the same source IP address and destination IP address combination are compared (step S33). The traffic monitoring apparatus that reports the largest TTL count having the greatest value is identified as the origin of the abnormality of the source IP address, in other words, a point at which the L3 loop has occurred (step S34), and the process returns to step S31. Hereafter, the sequence in the L3-loop-point identifying process described above is repeated.

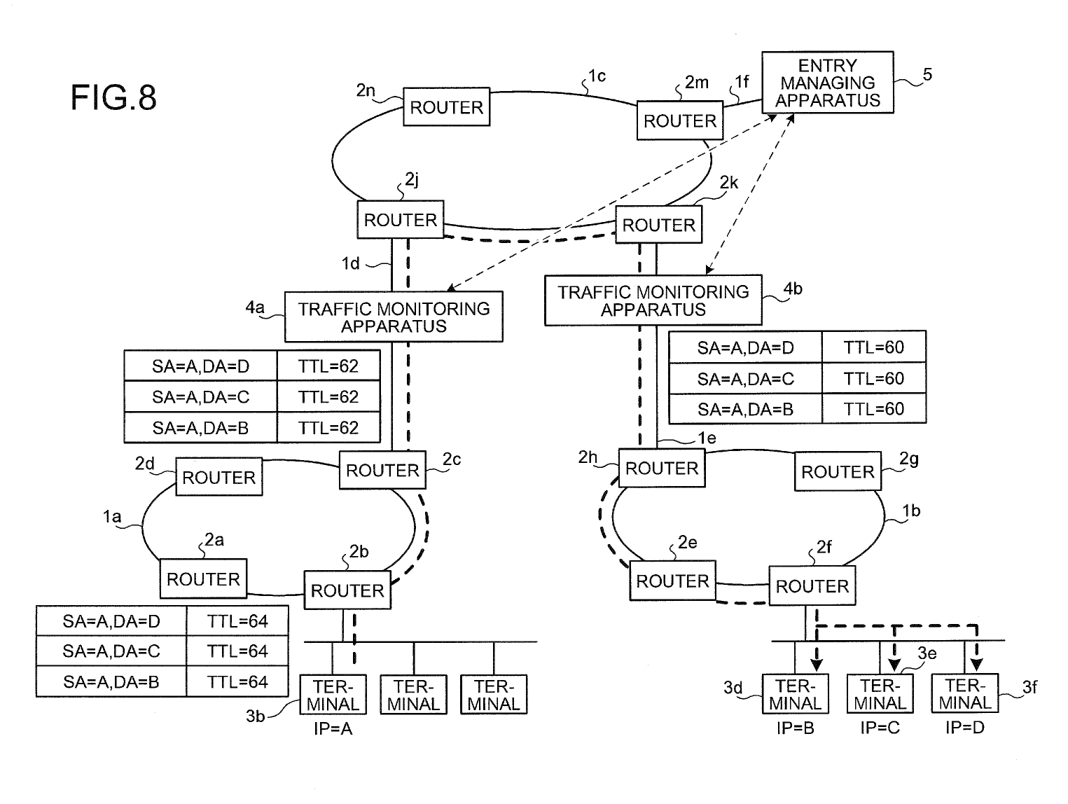

FIG. 8 is a schematic diagram showing a worm-source identifying operation in the network system. As shown in FIG. 8, a terminal 3b (IP address: A) that is affected by a worm such as a structured query language (SQL) slammer sends a packet to a number of terminals 3d, 3e, and 3f (IP address: B, C, D).

For example, when the affected terminal 3b sends a packet with the TTL value set to 64, the TTL value of the packet is decreased by 1 each time the packet passes each of the routers 2b, 2c, 2j, 2k, 2h, 2e, and 2f. Therefore, the TTL value of the packet having the same source IP address (A) and different destination IP addresses (B, C, D) is to be 62 in the first traffic monitoring apparatus 4a, and to be 60 in the second traffic monitoring apparatus 4b subsequent.

Both the traffic monitoring apparatuses 4a and 4b report the detected source IP addresses and TTL counts to the entry managing apparatus 5. The entry managing apparatus 5 compares the TTL counts reported by the traffic monitoring apparatuses 4a and 4b. As a result of comparison, it is determined that the TTL count reported by the first traffic monitoring apparatus 4a is larger. Accordingly, the entry managing apparatus 5 identifies the origin of the abnormality to exist on a side of the first traffic monitoring apparatus 4a.

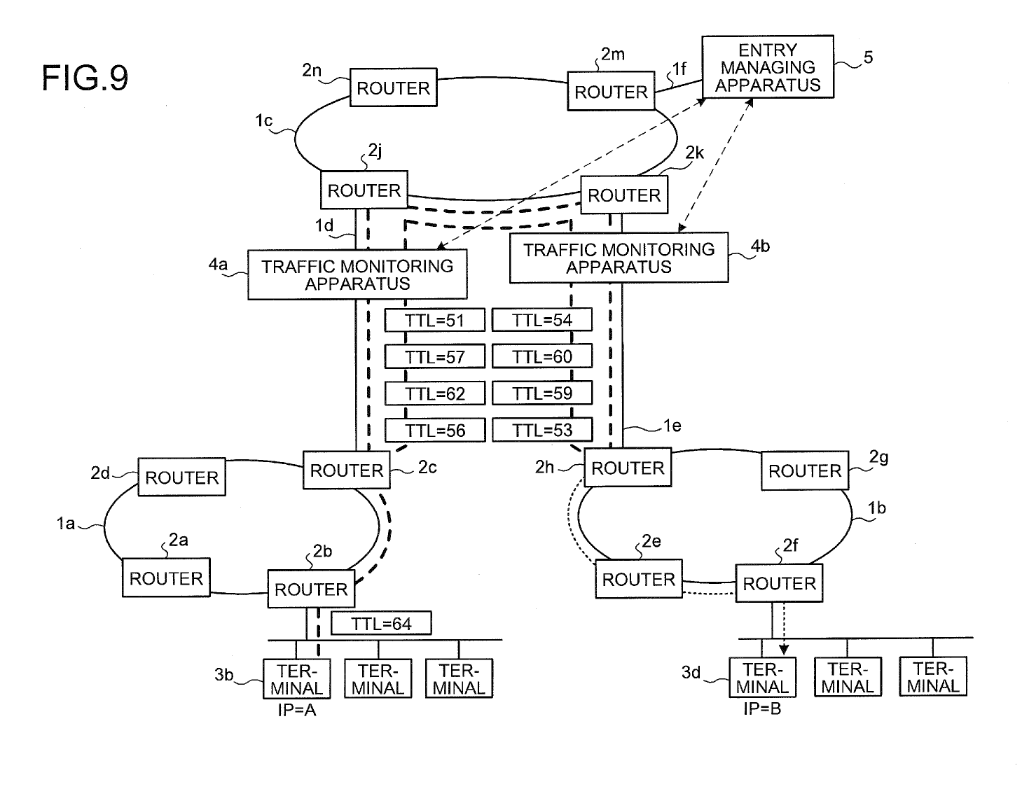

FIG. 9 is a schematic diagram showing an L3-loop-point identifying operation in the network system. As shown in FIG. 9, when an L3 loop occurs, a packet having the same source IP address and the same destination IP address is sent many times with different TTL counts.

For example, when the terminal 3b (IP address: A) sends a packet with the TTL value set to 64, the TTL value of the packet is decreased by 1 each time the packet passes each of the routers 2b, 2c, 2j, 2k, 2h, 2k, 2j, 2c, . . . . Therefore, the TTL count of the packet having the same source IP address (A) and the same destination IP addresses (B) takes 21 patterns of values, 62, 57, 56, 51, . . . , in total in the first traffic monitoring apparatus 4a. In this case, the largest TTL count is to be 62.

Similarly, the TTL count of the packet in the second traffic monitoring apparatus 4b takes 20 patterns of values, 60, 59, 54, 53, . . . , in total. In this case, the largest TTL count is to be 60. The traffic monitoring apparatuses 4a and 4b report the source IP addresses, the destination IP addresses, and the largest TTL counts detected by the traffic monitoring apparatuses 4a and 4b, respectively to the entry managing apparatus 5. The entry managing apparatus 5 compares the largest TTL counts reported by the traffic monitoring apparatuses 4a and 4b. As a result of comparison, it is found that the largest TTL count reported by the first traffic monitoring apparatus 4a is larger. Therefore, the entry managing apparatus 5 identifies that the origin of the abnormality exists on the side of the first traffic monitoring apparatus 4a.

As described above, according to the present embodiment, by collecting TTL counts or largest TTL counts of packets received by the traffic monitoring apparatuses 4a and 4b, and by comparing the collected TTL counts and the largest TTL counts, an origin of an abnormal traffic can be quickly identified without precisely checking information of each router. Therefore, even if the number of routers increases, the origin of abnormal traffic can be quickly identified. For example, even if the number of routers is large, the source causing the abnormal traffic can be identified in a few minutes.

In addition, even for traffic in which a false IP address is used, the source can be identified by comparing TTL counts. Furthermore, by monitoring a network at all times with the traffic monitoring apparatuses 4a and 4b and the entry managing apparatus 5, a point at which failure occurs in the network can be quickly identified. Therefore, spread of an abnormal traffic can be prevented. Moreover, even when a failure occurs in a network not under control, the network in which the failure is caused can be quickly detected.

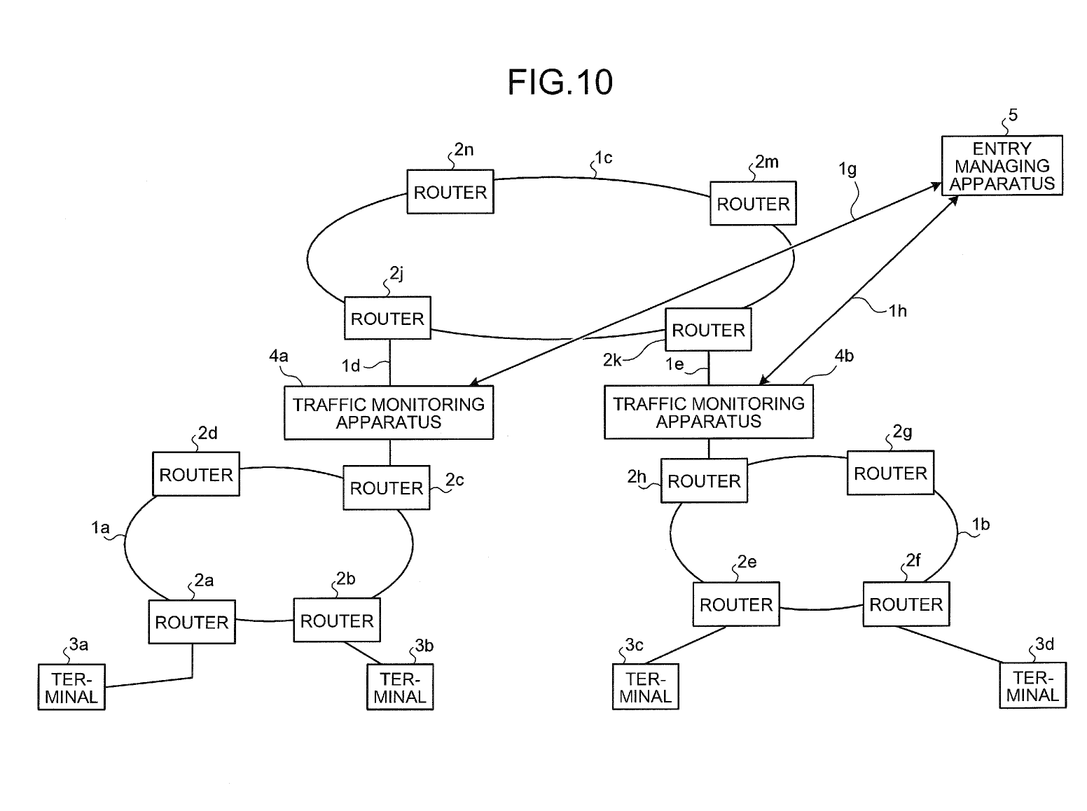

The present invention is not limited to the embodiment described above, and various modifications can be applied thereto. For example, as shown in FIG. 10, the communication paths 1g and 1h between the entry managing apparatus 5 and each of the traffic monitoring apparatuses 4a and 4b can be formed with a network for management such as a virtual local area network (LAN). Alternatively, the entry managing apparatus 5 and each of the traffic monitoring apparatuses 4a and 4b can be connected by a leased line. With such an arrangement, the communication path for management can be configured as a different path from a regular communication path, and therefore, even when a failure such as a break occurs in the regular communication path, an entry for management can be reported to the entry managing apparatus 5.

Moreover, a traffic monitoring apparatus can be provided between respective routers. Alternatively, a traffic monitoring apparatus can be equipped in a router. The present invention is not limited to identification of a point at which an abnormal traffic occurs due to a worm or an L3 loop, and can be applied to a case of identifying a source of such an abnormal traffic that a great number of packets are sent to various destination IP addresses, and a case of identifying a point at which such an abnormal traffic occurs that a packet whose source IP address is the same and the destination IP address is also the same is sent many times with different TTL counts.

According to the embodiment of the present invention described above, a point at which a failure is caused can be quickly identified.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A traffic monitoring apparatus comprising:
an extracting unit that extracts a source IP address, a destination IP address, and a time-to-live (TTL) count from a packet;
an entry registering unit that registers the source IP address, the destination IP address, and the TTL count as an entry;
a destination-address counting unit that counts a number of entries having a same first combination and a different destination IP address, for each first combination, the first combination being a combination of a source IP address and a TTL count; and
an entry reporting unit that reports, when the number of entries of the first combination exceeds a threshold, a source IP address and a TTL count of the first combination, the number of entries of which exceeds the threshold to a communication counterpart.

2. The traffic monitoring apparatus according to claim 1, further comprising a TTL counting unit that counts a number of entries having a same second combination and a different TTL count, for each second combination, the second combination being a combination of a source IP address and a destination IP address, and that finds a largest TTL count from among different TTL counts in each second combination.

3. The traffic monitoring apparatus according to claim 2, wherein the entry reporting unit reports, when the number of entries of the second combination exceeds a threshold, a source IP address and a largest TTL count of the second combination, the number of entries of which exceeds the threshold to the communication counterpart.

4. The traffic monitoring apparatus according to claim 1, wherein the entry that is registered by the entry registering unit and the number of entries that is counted by the destination-address counting unit are initialized in a predetermined cycle.

5. The traffic monitoring apparatus according to claim 2, wherein the number of entries that is counted by the TTL counting unit is initialized in a predetermined cycle.

6. An entry managing apparatus comprising:
an entry collecting unit that collects entries, each of which is formed with a combination of a source IP address and a TTL count, by receiving the entries from a plurality of communication counterparts; and
an entry comparing unit that compares TTL counts in the entries received from the communication counterparts for each source IP address, and that identifies a source that has sent an entry having a largest TTL count as an origin of an abnormality in a network.

7. The entry managing apparatus according to claim 6, wherein the entry comparing unit compares the TTL counts in a cycle determined in advance.

8. A network system comprising:
a plurality of traffic monitoring apparatuses that are provided in a network; and
an entry managing apparatus that is common to the traffic monitoring apparatuses, wherein
each of the traffic monitoring apparatus includes
an extracting unit that extracts a source IP address, a destination IP address, and a TTL count;
an entry registering unit that registers the source IP address, the destination IP address, and the TTL count as an entry;
a destination-address counting unit that counts a number of entries having a same first combination and a different destination IP address, for each first combination, the first combination being a combination of a source IP address and a TTL count; and
an entry reporting unit that reports, when the number of entries of the first combination exceeds a threshold, a source IP address and a TTL count of the first combination, the number of entries of which exceeds the threshold to the entry managing apparatus, and
the entry managing apparatus includes
an entry collecting unit that collects entries each of which is formed with a combination of a source IP address and a TTL count by receiving the entries from the traffic managing apparatuses; and
an entry comparing unit that compares TTL counts in the entries received from the traffic monitoring apparatuses for each source IP address, and that identifies a traffic monitoring apparatus that has sent an entry having a largest TTL count as an origin of an abnormality in the network.

9. The network system according to claim 8, wherein the traffic monitoring apparatus further includes a TTL counting unit that counts a number of entries having a same second combination and a different TTL count, for each second combination, the second combination being a combination of a source IP address and a destination IP address, and that finds a largest TTL count from among different TTL counts in each second combination.

10. The network system according to claim 9, wherein the entry reporting unit reports, when the number of entries of the second combination exceeds a threshold, a source IP address and a largest TTL count of the second combination, the number of entries of which exceeds the threshold to the entry managing apparatus.

11. The network system according to claim 8, wherein the traffic monitoring apparatuses report a source IP address and a TTL count to the entry managing apparatus regularly.

12. The network system according to claim 8, wherein the entry managing apparatus collects the entries regularly.

13. The network system according to claim 8, wherein the entry managing apparatus communicates with the traffic monitoring apparatuses using a network for management.
